(19) United States
(12) Patent Application Publication
(10) Pub. No.: US 2025/0196772 A1
(43) Pub. Date: Jun. 19, 2025

(54) INFORMATION PROCESSING APPARATUS

(71) Applicant: TOYOTA JIDOSHA KABUSHIKI KAISHA, Toyota-shi (JP)

(72) Inventors: Yuki TATSUMOTO, Seto-shi (JP); Josuke YAMANE, Nagoya-shi (JP); Hirotaka NOGAMI, Nisshin-shi (JP); Kazuya NISHIMURA, Anjo-shi (JP); Takumi FUKUNAGA, Iwakura-shi (JP)

(73) Assignee: TOYOTA JIDOSHA KABUSHIKI KAISHA, Toyota-shi (JP)

(21) Appl. No.: 18/966,127

(22) Filed: Dec. 3, 2024

(30) Foreign Application Priority Data
Dec. 15, 2023 (JP) 2023-212408

(51) Int. Cl. B60R 1/26

(52) U.S. Cl. CPC B60R 1/26; B60R 2300/8093

(57) ABSTRACT

An information processing apparatus includes a controller and a display, wherein the controller is configured to determine a reference distance based on a maximum protrusion length toward a vehicle rear side during opening and closing operation of a back door, and display on a back view screen using the display, upon detection of a rear obstacle at a time of a start of parking a vehicle, a guide image indicating a position that is distant from the rear obstacle by the reference distance.

### CROSS-REFERENCE TO RELATED APPLICATION

This application claims priority to Japanese Patent Application No. 2023-212408 filed on Dec. 15, 2023, the entire contents of which are incorporated herein by reference.

### TECHNICAL FIELD

The present disclosure relates to an information processing apparatus.

### BACKGROUND

Technology related to a rear-view monitor that displays expected path lines and distance guide lines on a rear image of a vehicle to support the parking operation of the vehicle is disclosed. For example, see Patent Literature (PTL) 1.

### CITATION LIST

### Patent Literature

PTL 1: JP 2013-063770 A

### SUMMARY

For example, a user may open and close the back door after parking in order to use the trunk at the rear of a vehicle. Depending on the structure of the back door, the back door may protrude toward the rear side of the vehicle during the opening and closing operation. In such cases, it is desirable to park the vehicle at a certain distance from obstacles (walls or the like) on the rear side of the vehicle. However, conventional rear-view monitors cannot necessarily support parking at an appropriate distance from obstacles on the rear side of the vehicle because the protrusion length of the back door is not considered. Thus, there is room for improvement with respect to technology for supporting vehicle parking operations.

It would be helpful to improve technology for supporting vehicle parking operations.

An information processing apparatus according to an embodiment of the present disclosure includes:
a controller; and
a display,
wherein the controller is configured to:
   determine a reference distance based on a maximum protrusion length toward a vehicle rear side during opening and closing operation of a back door; and
   display on a back view screen using the display, upon detection of a rear obstacle at a time of a start of parking a vehicle, a guide image indicating a position that is distant from the rear obstacle by the reference distance.

According to an embodiment of the present disclosure, technology for supporting vehicle parking operations is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus;

FIG. 3 is a flowchart illustrating operations of the information processing apparatus; and

FIG. 4 is a diagram illustrating an example of a guide image.

### DETAILED DESCRIPTION

Hereinafter, an embodiment of the present disclosure will be described.

### Outline of Embodiment

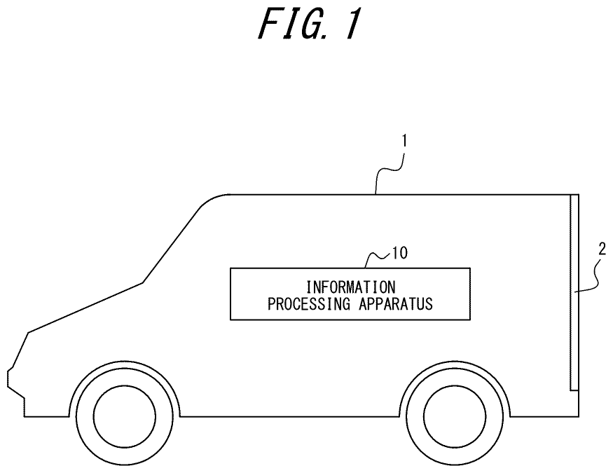

An outline of technology according to an embodiment of the present disclosure will be described with reference to FIG. 1. The technology according to the embodiment of the present disclosure includes a vehicle 1 and an information processing apparatus 10 mounted in the vehicle 1.

The vehicle 1 is an automobile, for example, but is not limited to this and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The vehicle 1 has a back door 2, and during the opening and closing operation of the back door 2, the back door 2 protrudes toward the vehicle rear side.

The information processing apparatus 10 is any apparatus to be used by an occupant in the vehicle 1. For example, a dedicated in-vehicle device such as a rear-view monitor device can be employed as the information processing apparatus 10.

First, an outline of the present embodiment will be described, and details thereof will be described later. The information processing apparatus 10 determines a reference distance based on the maximum protrusion length toward the vehicle rear side during opening and closing operation of a back door 2. Upon detection of a rear obstacle at a time of a start of vehicle parking, the information processing apparatus 10 displays on a back view screen a guide image indicating a position that is distant from the rear obstacle by the reference distance.

Thus, according to the present embodiment, when a rear obstacle is detected at the time of a start of vehicle parking, the information processing apparatus 10 displays on the back view screen a guide image indicating a position that is distant from the rear obstacle by the reference distance. The reference distance is defined based on the maximum protrusion length toward the vehicle rear side during the opening and closing operation of the back door. Thus, the technology for supporting vehicle parking operations is improved in that it can support parking in relation to rear obstacles when the user opens and closes the back door after parking.

### Configuration of Information Processing Apparatus

Next, configurations of the information processing apparatus 10 will be described in detail. The information processing apparatus 10 is any apparatus to be used by a user.

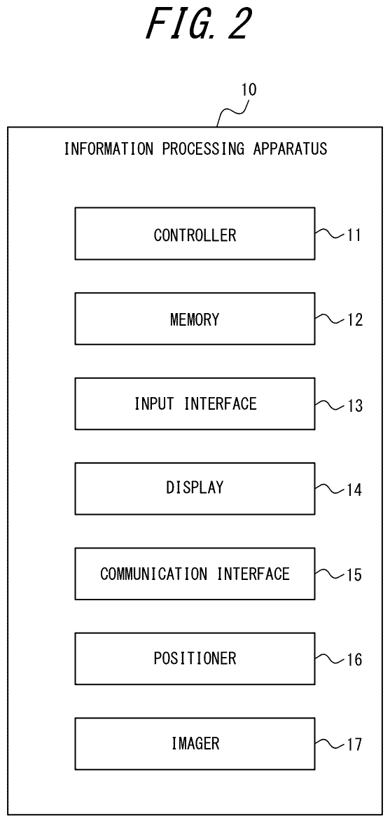

As illustrated in FIG. 2, the information processing apparatus 10 includes a controller 11, a memory 12, an input interface 13, a display 14, a communication interface 15, a positioner 16, and an imager 17.

The controller 11 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores data to be used in the operations of the information processing apparatus 10 and data obtained by the operations of the information processing apparatus 10.

The input interface 13 includes at least one interface for input. The interface for input is, for example, a physical key, a capacitive key, a pointing device, or a touch screen integrally provided with a display. The interface for input may be, for example, a sound sensor that accepts audio input, a camera that accepts gesture input, or the like. The input interface 13 accepts an operation for inputting data to be used for the operations of the information processing apparatus 10. The input interface 13 may be connected to the information processing apparatus 10 as an external input device, instead of being included in the information processing apparatus 10. As the connection method, for example, any method such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The display 14 includes at least one interface for display output. The interface for display output is, for example, a display that displays the back view or the like. The back view is image information showing the outside scenery at the rear of the vehicle. The display is, for example, a liquid crystal display (LCD) or an organic electro luminescent (EL) display. The display 14 displays and outputs data obtained by the operations of the information processing apparatus 10. The display 14 may be connected to the information processing apparatus 10 as an external output device, instead of being included in the information processing apparatus 10. As the connection method, any technology such as USB, HDMI®, or Bluetooth® can be used.

The communication interface 15 includes a communication interface for connection to a network. For example, the communication interface 15 may be equipped with a communication interface that connects to CAN. The communication interface for connection to the network is compliant with mobile communication standards, or the like, but is not limited to these and may be compliant with any communication standard. In the present embodiment, the information processing apparatus 10 that one mobile object has is wirelessly connected to the information processing apparatus that another mobile object has via the communication interface 15 and the network. The communication interface 15 receives data to be used for the operations of the information processing apparatus 10, and transmits data obtained by the operations of the information processing apparatus 10.

The positioner 16 includes one or more apparatuses that acquire positional information for the information processing apparatus 10 (i.e., positional information for the vehicle 1). Specifically, the positioner 16 includes, for example, a receiver compliant with GPS, but is not limited to this example and may include a receiver compliant with any appropriate satellite positioning system.

The imager 17 includes an in-vehicle camera that generates images, which are captured images of the outside scenery at the rear of the vehicle 1. In the present embodiment, the “images” may be still images or moving images. The in-vehicle camera included in the imager 17 may be a monocular camera or a stereo camera. The imager 17 is installed in the vehicle 1 so that the imager 17 can capture images of the outside scenery at the rear of the vehicle 1. The imager 17 captures an image of the outside scenery at the rear of the vehicle 1, thereby enabling the aforementioned back view to be displayed on the display 14.

The functions of the information processing apparatus 10 may be implemented by a processor corresponding to the information processing apparatus 10 executing a program according to the present embodiment. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

Some or all of the functions of the information processing apparatus 10 may be realized by a dedicated circuit corresponding to the controller 11. That is, some or all of the functions of the information processing apparatus 10 may be realized by hardware.

### Operations of Information Processing Apparatus)

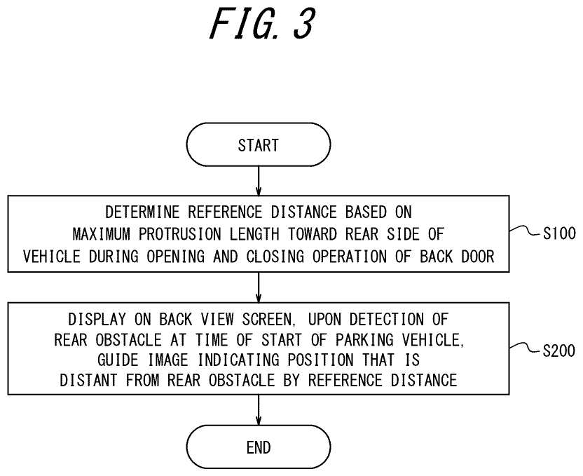

The operations of the information processing apparatus 10 according to the present embodiment will be described with reference to FIG. 3.

Step S100: The controller 11 of the information processing apparatus 10 determines the reference distance based on the maximum protrusion length toward the vehicle rear side during the opening and closing operation of the back door. For example, the controller 11 determines the reference distance within a range that is not less than a protrusion length at a time when an opening degree of the back door is the minimum opening degree required for loading and unloading baggage in a trunk, and is not longer than the maximum protrusion length.

Step S200: Upon detection of the rear obstacle at a time of a start of vehicle parking, the controller 11 displays on the back view screen using the display 14 a guide image indicating a position that is distant from the rear obstacle by the reference distance. Any appropriate method can be employed to detect rear obstacles. For example, detection of rear obstacles may be performed by image recognition of the rearward image captured by the imager 17. Rear obstacles may also be detected, for example, by sensors.

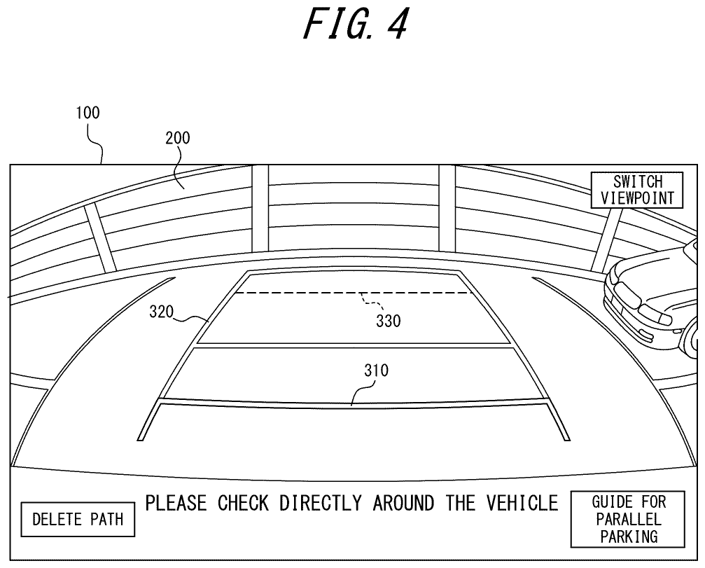

FIG. 4 is an example of a user interface 100 that includes the above guide image. The user interface 100 includes a rear obstacle 200 (in this case a wall), a first line image 310, a second line image 320, and a guide image 330. The first line image 310 is a guide that shows a predetermined distance ahead from the rear of the vehicle. For example, the first line image 310 is displayed at a position 0.5 m ahead of the rear of the vehicle. The second line image 320 is a guide to the expected path. For example, the second line image 320 is displayed at a position 3 m ahead of the rear of the vehicle, depending on the state of the steering wheel. The guide image 330 shows a position that is distant from the rear obstacle 200 by the reference distance. Based on the guide image 330, the driver can easily park a reference distance away from the rear obstacle 200.

As described above, the information processing apparatus 10 according to the present embodiment displays on the back view screen, upon detection of a rear obstacle at the time of a start of vehicle parking, a guide image indicating a position that is distant from the rear obstacle by a reference distance. The reference distance is defined based on the maximum protrusion length toward the vehicle rear side during the opening and closing operation of the back door. Thus, the technology for supporting vehicle parking operations is improved in that it can support parking in relation to rear obstacles when the user opens and closes the back door after parking.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, the controller 11 may determine the reference distance based further on information on the baggage loaded in the trunk of the vehicle 1. The information on the baggage includes, for example, the size, weight, and contents of the baggage. For example, the larger or heavier the baggage, the longer the reference distance may be. This allows the appropriate reference distance to be determined according to the information on the baggage.

For example, the controller 11 may display a guide image using the display 14 according to the positional information for the vehicle 1 at a time of parking. The controller 11 acquires such positional information using the positioner 16. For example, in a case in which the positional information for the vehicle 1 at the time of parking substantially matches a predetermined reference position, the controller 11 may display the guide image using the display 14. The predetermined reference position may include the position of facilities (e.g., shopping malls) where the trunk is likely to be used.

For example, the controller 11 may store track record information indicating the number of times the back door has been opened and closed for each past parking position of the vehicle 1. In such cases, the reference position may include any parking position for which the number of openings and closings is greater than or equal to the threshold in the relevant performance information.

1. An information processing apparatus comprising:
a controller; and
a display,
wherein the controller is configured to:
determine a reference distance based on a maximum protrusion length toward a vehicle rear side during opening and closing operation of a back door; and
display on a back view screen using the display, upon detection of a rear obstacle at a time of a start of parking a vehicle, a guide image indicating a position that is distant from the rear obstacle by the reference distance.

2. The information processing apparatus according to claim 1, wherein the controller is configured to determine the reference distance within a range that is not less than a protrusion length at a time when an opening degree of the back door is a minimum opening degree required for loading and unloading baggage in a trunk, and is not longer than the maximum protrusion length.

3. The information processing apparatus according to claim 1, wherein the controller is configured to determine the reference distance based further on information on baggage loaded in a vehicle trunk.

4. The information processing apparatus according to claim 1, wherein the controller is configured to display the guide image using the display according to positional information for the vehicle at a time of parking.

5. The information processing apparatus according to claim 1, wherein the controller is configured to display the guide image in a case in which positional information for the vehicle at a time of parking substantially matches a predetermined reference position.
